(19) United States
(12) Patent Application Publication
(10) Pub. No.: US 2020/0005293 A1
(43) Pub. Date: Jan. 2, 2020

(54) CRYPTOCURRENCY GREETING CARDS

(71) Applicant: Babajide Emmanuel Opeola, Atlanta, GA (US)

(72) Inventor: Babajide Emmanuel Opeola, Atlanta, GA (US)

(21) Appl. No.: 16/457,848

(22) Filed: Jun. 28, 2019

Related U.S. Application Data
(60) Provisional application No. 62/692,837, filed on Jul. 1, 2018.

(51) Int. Cl. G06Q 20/38; G06K 19/06; G06Q 20/36

(52) U.S. Cl. CPC G06Q 20/3829; G06Q 2220/00; G06Q 20/3674; G06K 19/06037

(57) ABSTRACT

A system and method of transferring cryptocurrency using printed media or digital media, such as greeting cards and digital greeting cards. One example method may comprise one or more of a user selecting a style of greeting card; the user selecting an amount of cryptocurrency to load onto the greeting card; the user sending transaction information to a server; the server communicating with a blockchain network to create digital keys and cryptocurrency addresses, one of which serves as an escrow account; printing a QR code representing the other address on the greeting card; sending the card to a recipient; and the recipient activating this account by scanning the QR code, which authorizes the transfer of value from the escrow account to the recipient's account using activation codes and encrypted private digital keys.

### CROSS-REFERENCE TO RELATED APPLICATIONS

This application claims the benefit of the following provisional application, which is hereby incorporated by reference in its entirety: application Ser. No. 62/692,837, CRYPTOCURRENCY GREETING CARDS, filed Jul. 1, 2018 by Babajide Emmanuel Opeola.

### TECHNICAL FIELD

This application relates to transferring value between two or more parties, and more specifically to leveraging blockchains, smart contracts, websites, and retail points-of-sale to transfer cryptocurrency by way of physical and digital greeting cards and gift cards.

### BACKGROUND

Both the gift card and greeting card industries are lucrative, but the physical constrains of using these cards presents limitations to their flexibility and usefulness. Specifically, the inconvenience and risk of transferring physical currency, money orders, or checks through the mail; having to buy physical cards, in which currency is later mailed, in stores; and having to physically carry gift cards in order to redeem them for value, make them less attractive options for transferring value, especially in the age of blockchains and cryptocurrencies. The invention of the subject disclosure overcomes these limitations by providing systems, methods, and apparati of purchasing greeting cards and gift cards online, which may be loaded with value facilitated by blockchain and cryptocurrency technology, and which may be both more securely transferred and more readily accessible to recipients thanks to private key technology, digital wallets, and QR codes. These new systems, methods, apparati, and computer code meet a need unmet by the current state of the art and bridge a considerable gap between available methods of sending and receiving monetary gifts, and consumer expectations for value transfer in the era of digital currency.

### SUMMARY

One example embodiment may include a method that comprises printing a QR code, which corresponds to a digital currency wallet, on a printed media, including, but not limited to, greetings cards, gift cards, postcards, business cards, flyers, receipts, and cryptocurrency checks, order paper, or other negotiable instruments. Specifically, an embodiment of the method comprises a user selecting a style of greeting card, a unit of value, and an amount of the unit of value, such as, e.g., a cryptocurrency, to load onto the selected greeting card; the user transmitting his or her cryptocurrency digital address and a recipient's contact information to a server, which calculates the costs of a transaction; the user authorizing the transaction; the server creating an escrow account to store value sent in the transaction and a secure account for a recipient; the server creating a digital means of implementing the transaction according to predetermined criteria, such as a smart contract, and storing persistent information about the transaction on a cloud storage database; the recipient digital address being printed on the greeting card as a QR code, which is sent to the recipient; the recipient using a mobile application to scan the QR code printed on the greeting card; the mobile application querying the server for information about the recipient digital address, and the server transmitting a response including an authorization code that the recipient uses to activate the secure recipient account and authorize the server to transfer cryptocurrency value into the recipient's account from the escrow.

Another example embodiment may include a system that comprises one or more websites configured to receive user input and display cryptocurrency transaction data; one or more mobile applications configured to receive user input, interpret secure recipient account information printed on a printed medium, and display cryptocurrency transaction data; one or more servers configured to receive user input, calculate cryptocurrency transaction costs, communicate with blockchain networks to create cryptocurrency digital wallets from encrypted digital private key information, transmit cryptocurrency transaction data to mobile applications and blockchain networks, and implement cryptocurrency value transfers between cryptocurrency addresses; one or more payment networks configured to receive, process, and confirm cryptocurrency transactions, and communicate using webhook technology; one or more smart contracts configured to administer the transfer of cryptocurrency value according to predetermined criteria; one or more multi-signature wallets configured to administer the transfer of cryptocurrency value according to predetermined criteria and subject to the provision of digital authorization keys; one or more blockchain networks configured to create cryptocurrency wallets and transaction data and stored transaction data in decentralized and immutable blocks of data; one or more cloud storage databases configured to store persistent cryptocurrency transaction data, cryptocurrency digital addresses, and encrypted digital keys; one or points-of-sale configured to receive user input, load secure cryptocurrency transaction data onto printed media, and display cryptocurrency transaction data.

Still another example embodiment may include a non-transitory computer readable storage medium configured to store instructions that when executed causes a processor to perform one or more of: receiving user input selecting a printed medium from among a plurality of available printed media; receiving user input selecting a unit of value from among a plurality of available units of value; receiving user input selecting an amount of the selected unit of value to load onto the selected printed medium; receiving user input providing contact information for a recipient of value; receiving user input providing account information for a transmitter of value; transmitting information pertaining to the selected printed medium, unit of value, and amount, and provided contact information and account information to a server; leveraging the server to calculate the costs of a transaction based on the information; receiving user input authorizing the transaction; leveraging the server to create an escrow account to store value sent in the transaction; leveraging the server to create a secure recipient account for a recipient; leveraging the server to create a digital means of implementing the transaction according to predetermined criteria; leveraging the server to store persistent information about the transaction; leveraging the server to cause secure recipient account information to be printed on the printed medium; interpreting the secure recipient account information printed on the printed medium; querying the server for information about the secure recipient account; leveraging the server to transmit a response to the query with information about the secure recipient account and the transaction; receiving recipient input to activate the secure recipient account and authorize transfer value into the recipient account; and leveraging the server to transfer value from the transaction from the escrow account to the recipient account.

### BRIEF DESCRIPTION OF THE DRAWINGS

Various exemplary embodiments of this disclosure will be described in detail, wherein like reference numerals refer to identical or similar components or steps, with reference to the following figures, wherein:

FIG. 1 illustrates a schematic diagram of an example website-based card purchase system configuration according to example embodiments.

FIG. 2 illustrates a schematic diagram of an example in-person, store-based card purchase system configuration according to example embodiments.

FIG. 3 illustrates a block diagram of the input and output of information interacting with a server according to example embodiments.

FIG. 4 illustrates a block diagram of the input and output of information interacting with a server or blockchain network, specifically related to a user paying for a transaction, according to example embodiments.

FIG. 5 illustrates a block diagram of the input and output of information interacting with a server, specifically related to back-end data storage, according to example embodiments.

FIG. 6 illustrates a method of transferring digital currency, also known as cryptocurrency, using QR CODE-enabled greeting cards by way of an online system, such as a website or smartphone application.

FIG. 7 illustrates a method of transferring digital currency, also known as cryptocurrency, using QR CODE-enabled greeting cards by way of an in-person system, such as at a store or kiosk point-of-sale.

### DETAILED DESCRIPTION

It will be readily understood that the instant components, as generally described and illustrated in the figures herein, may be arranged and designed in a wide variety of different configurations. Thus, the following detailed description of the embodiments of at least one of a method, apparatus, non-transitory computer readable medium, and system, as represented in the attached figures, is not intended to limit the scope of the application as claimed, but is merely representative of selected embodiments.

The instant features, structures, or characteristics as described throughout this specification may be combined in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one embodiment. Thus, appearances of the phrases “example embodiments”, “in some embodiments”, “in other embodiments”, or other similar language, throughout this specification do not necessarily all refer to the same group of embodiments, and the described features, structures, or characteristics may be combined in any suitable manner in one or more embodiments.

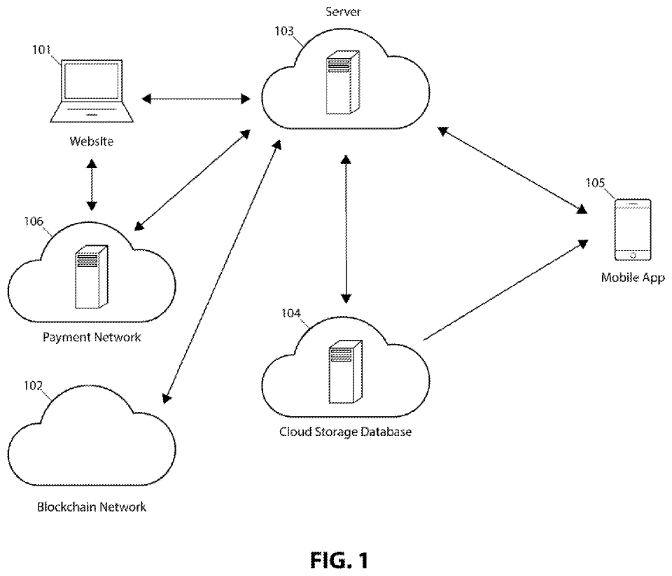

FIG. 1 illustrates a system of connected devices that may facilitate a user purchasing a value-loaded greeting card or gift card from a website. The system may consist of components including, but not limited to, a website 101, a blockchain network 102, a server 103, a cloud storage database 104, a mobile application 105, and a payment network 106. Server 103 may be any suitable device known in the art, such as, e.g., an event-driven, serverless computing platform that executes computer code without provisioning and managing its own servers. It may process compute code in response to events and automatically manage computing resources required by computer code. Blockchain network 102 may be any suitable network known in the art, such as, e.g., a decentralized public ledger used to record transactions across a network of computers, it may not be owned by any single entity, and it may have a series of immutable records called blocks. Cloud storage database 104 may be any suitable storage platform used to store persistent information.

The user may first access the platform through a website 101. From there, the user may choose a card, such as, e.g., a physical printed card or a digital card, select which cryptocurrency they want to load onto the card, enter the value of cryptocurrency to load onto the card, and enter a recipient's phone number and digital wallet address. The user may then transfer the total payment, which may include the value to be transferred in addition to the cost of the transfer itself, which may be expressed in any units known in the art, such as, e.g., “gas,” “coins,” or other value, to a payment network 106. Once the validity of the transaction is verified and confirmed, payment network 106 may send a payment status back to website 101 via any method known in the art, such as, e.g., webhook, a web callback, or an HTTP push API. Next, website 101 may send the greeting card information to server 103 via webhook.

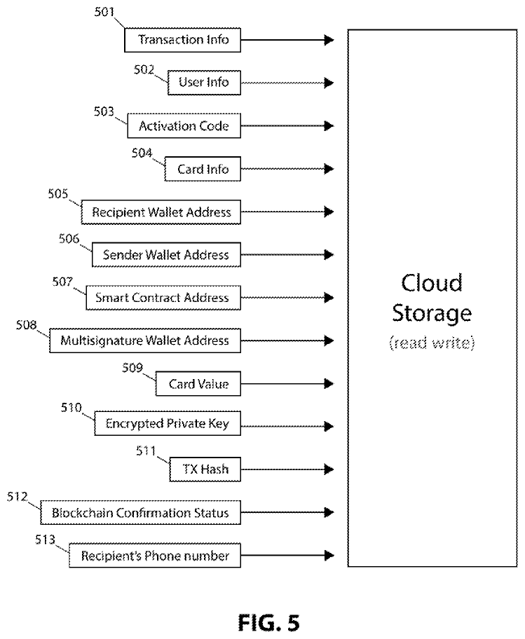

Server 103 may then process user's request to purchase a card. Server 103 may communicate with blockchain network 102 to create a digital wallet for a recipient, as well as an escrow wallet, such as, e.g., a smart contract or multi-signature wallet, to store cryptocurrency value. Afterwards, this information may be stored in cloud storage database 104, from which it may be accessed later, as explained in the description for FIG. 5. Once the recipient receives the card, such as, e.g., a physical printed card or a digital card, recipient may download a mobile application 105, which may be used to scan a code, such as, e.g. a quick response or “QR” code, which may be a representation of a private key for the recipient's digital wallet.

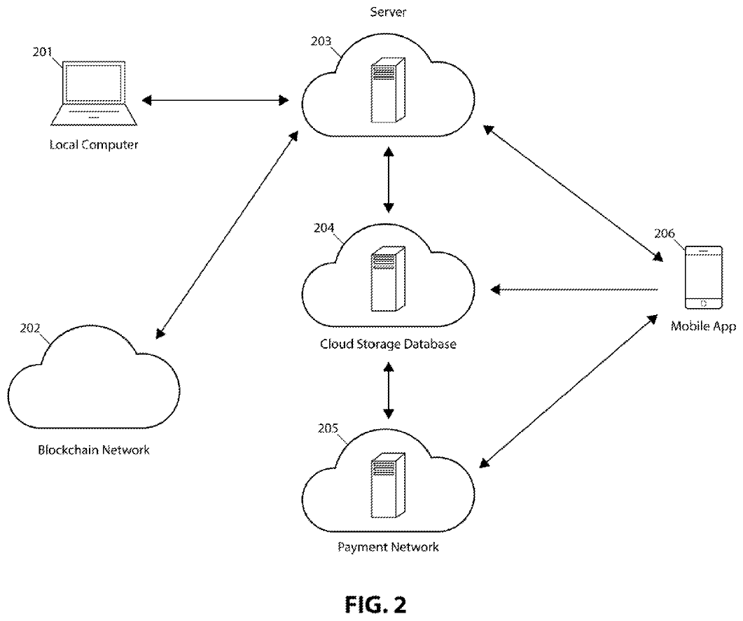

FIG. 2 illustrates a system of connected devices that may facilitate a user purchasing a value-loaded greeting card or gift card in person or at a store. The system may consist of components including, but not limited to, a local computer 201, a blockchain network 202, a server 203, a cloud storage database 204, a payment network 205, and a mobile application 206. Server 203 may be any suitable device known in the art, such as, e.g., an event-driven, serverless computing platform that executes computer code without provisioning and managing its own servers. It may process compute code in response to events and automatically manage computing resources required by computer code. Blockchain network 202 may be any suitable network known in the art, such as, e.g., a decentralized public ledger used to record transactions across a network of computers, it may not be owned by any single entity, and it may have a series of immutable records called blocks. Cloud storage database 204 may be any suitable storage platform used to store persistent information.

In this embodiment, all cards may have a private key representation, such as, e.g., a QR code, printed on them prior to sale. This private key may belong to the digital wallet that would hold a yet-to-be-determined recipient's cryptocurrency value once loaded by a user. A program may be executed on a local computer 201 to communicate with server 203, which may then communicate with blockchain network 202 to create new digital wallets. Information about the digital wallets may then be stored in cloud storage database 204. Then, server 203 may transmit digital wallet information to local computer 201, which may be housed in a point-of-sale kiosk at a store. The digital wallet private keys may then be printed onto cards in any suitable format known in the art, such as, e.g., a QR code. Once a user purchases a card, the user may download a mobile application 206, which may facilitate the user loading the card with cryptocurrency value. The user may first scan a QR Code on the card, after which mobile application 206 may generate a digital wallet address locally, based on the private key on the card, and query cloud storage database 204 for information about this newly scanned digital wallet.

Once cloud storage database 204 responds to the query with information about the associated digital wallet, the user may use mobile application 206 to enter a desired amount of cryptocurrency value to load onto the card along with the recipient's phone number and the user's digital wallet address, to which refunds related to the transaction may be transferred. When the user is satisfied with amount of cryptocurrency value to be transferred, transfer fees may be calculated and added to the transaction amount, and the user may select a payment method. Information about the total transaction cost may then be transmitted to payment network 205, which may process the payment request and return a digital wallet address and cryptocurrency equivalent of the price in fiat currency, such as, e.g., United States Dollars. The user may then send the full cryptocurrency amount to the payment wallet address, and mobile app 206 may send all relevant data of this transaction to cloud storage database 204.

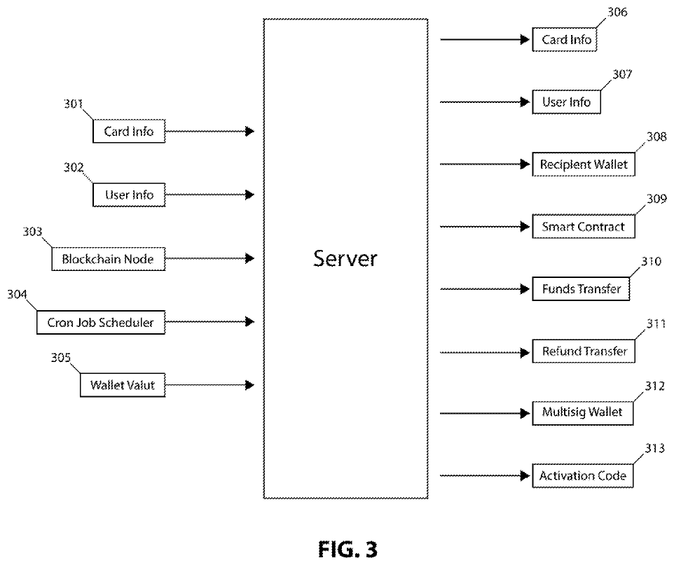

FIG. 3 illustrates all input and output information that may interact with and be produced by server 103 or 203, as explained in FIGS. 1 and 2. The input information may include, but not be limited to, card information 301, user information 302, a blockchain node 303, a cron job scheduler 304, and a wallet vault 305. The output information may include, but not be limited to, card information 306, user information 307, a recipient wallet 308, a smart contract 309, a funds transfer 310, a refund transfer 311, a multi-signature wallet 312, and an activation code 313. Cron job scheduler 304 may be any suitable scheduling daemon that executes computer system tasks at specified intervals. Smart contract 309 may be any suitable digital contract facilitated or administered by computer code, such as ,e.g., Solidity, and deployed to any suitable blockchain, such as, e.g., the Ethereum blockchain.

Server 103 may use card info 301 for all interactions to help identify for which card a current server instance is running. User info 302 may be used to associate users with cards that were loaded in-person. When a user has completed payment for a loaded card, server 203 may send user a “push,” or other suitable notification known in the art, to notify user that an escrow wallet, such as, e.g., a smart contract or multi-signature wallet, has been created. User info 302 may facilitate this process by storing unique push notification credentials of the user's device. Server 203 may have computer code that may automate the creation of both smart contracts and multi-signature wallets, and live blockchain node 303 belonging to the cryptocurrency's blockchain may be running on server 203 to facilitate the creation of smart contracts and wallets.

Some processes, such as, e.g., smart contract 309 creation, multi-signature wallet 312 creation, and automatic refund transfer 311, may be based on a cron job scheduler 304 timer. A cron job may sweep cloud storage database 104 or 204 at a predetermined frequency of time to identity entries with certain states. Based on those states, events may be triggered leading to escrow wallet creation and refunds, as described above. When a user transmits a payment, the cryptocurrency value may be sent to payment network 205, and wallet vault 305 may transmit cryptocurrency value to an escrow wallet, such as, e.g., smart contract 309 or multi-signature wallet 312. Once an escrow wallet is created for the card, server 103 or 203 may generate activation code 313, which may be stored in cloud storage database 104 or 204. Activation code 313 may protect the cryptocurrency value in the escrow wallet from theft by unauthorized parties. When entered correctly for the specific wallet, cryptocurrency value may then be transferred from the escrow wallet to the appropriate recipient's digital wallet.

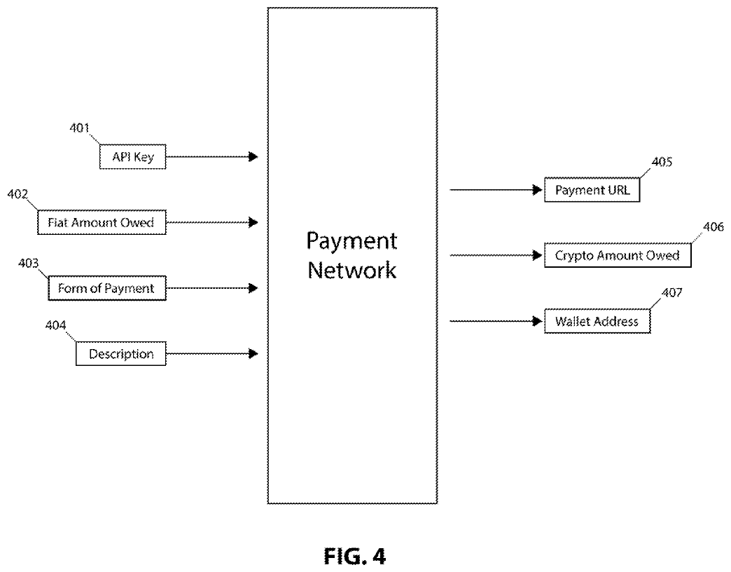

FIG. 4 illustrates all input and output information that may interact with payment network 106 or 205, as explained in FIGS. 1 and 2. The input information may include, but not be limited to, application program interface (“API”) key 401, fiat amount owed 402, form of payment 403, and description 404. The output information may include, but not be limited to, payment uniform resource locator (“URL”) 405, cryptocurrency amount owed 406, and wallet address 407. Fiat amount owed 402 may be user's outstanding balance, and description 404 may highlight the purpose of value transfer. Payment URL 405 may show information related to the processed payment including, but not limited to, receipt and payment verification status, such as, e.g., that the payment status is “paid.” Cryptocurrency amount owed 406 may reflect the cryptocurrency equivalent of the total payment based on the current market price of the selected cryptocurrency. Wallet address 407 may represent the address that a user should send the payment to once a transfer has been confirmed on the blockchain. Upon a user's payment transmission, server 103 or 203 may transmit to payment network 106 or 205 using API key 401, fiat amount owed 402, user's selected form of payment 403, and a description 404. Payment network 106 or 205 may then respond to user with payment URL 405, cryptocurrency amount owed 406, and wallet address 407.

FIG. 5 illustrates the information being persisted inside of the cloud storage database 104 or 204, as explained in FIGS. 1 and 2. The information may include, but not be limited to, transaction information 501, user information 502, an activation code 503, card information 504, a recipient wallet address 505, a sender wallet address 506, a smart contract address 507, a multi-signature wallet address 508, a card value 509, an encrypted private key 510, a transaction (“tx”) hash 511, a blockchain confirmation status 512, and a recipient's telephone number 513. Transaction info 501 may be any information associated with the transaction. Each transaction may have a unique identifier, along with a card stock-keeping unit (“SKU”) number. User information 502 may be suitable information known in the art about the user, including, but not limited to, a push notification token, card information, and a phone number. Activation code 503 may be an alphanumeric code that may protect the cryptocurrency assets from unauthorized access. Card info 504 may consist of the card's SKU and the value of cryptocurrency loaded on the card. Recipient's wallet address 505 may be the digital wallet address, which is created for the end user and printed on the physical card itself.

Recipient's wallet address 505 may be used to claim cryptocurrency funds by scanning it with mobile application 105 or 206, as explained in FIGS. 1 and 2, and once enabled, the digital wallet associated with recipient's wallet address 505 may be activated. Sender wallet address 506 may only be used for refunds in predetermined scenarios, such as, e.g., when cryptocurrency funds are not claimed by a recipient. Smart contracts 309 may be equipped with computer code that may automatically refund the sender wallet address 506 after a predetermined duration of time or when predetermined conditions are satisfied. By contrast, refunding a multi-signature wallet 312 may be a manual process. Smart contract address 507 and multi-signature wallet address 508 may serve as escrow accounts to store cryptocurrency funds, and the addresses to these wallets may be stored persistently on cloud storage database 104 or 204. Card value 509 may be the cryptocurrency value that a user wishes to load onto a card. Encrypted private key 510, which may be printed on a card and stored in cloud storage database 204, may be required when using certain cryptocurrencies.

Transaction hash 511 may be the transfer hash associated with a transfer of value from an escrow account, such as, e.g., smart contract address 507 or multi-signature wallet address 508, to recipient's wallet address 505. Along with transaction hash 511, blockchain confirmation status 512 may represent the status of the transfer on a blockchain network 102 or 202 as explained in FIGS. 1 and 2. As a blockchain may require that every transaction be confirmed, blockchain confirmation status 512 may notify server 103 or 203 when confirmation occurs. Recipient's phone number 513 may be used to transmit to recipient an activation code, which may be used to activate the card and unlock cryptocurrency funds from the escrow account, such as, e.g., smart contract address 507 or multi-signature wallet address 508, and transfer the cryptocurrency funds to recipient's wallet address 505.

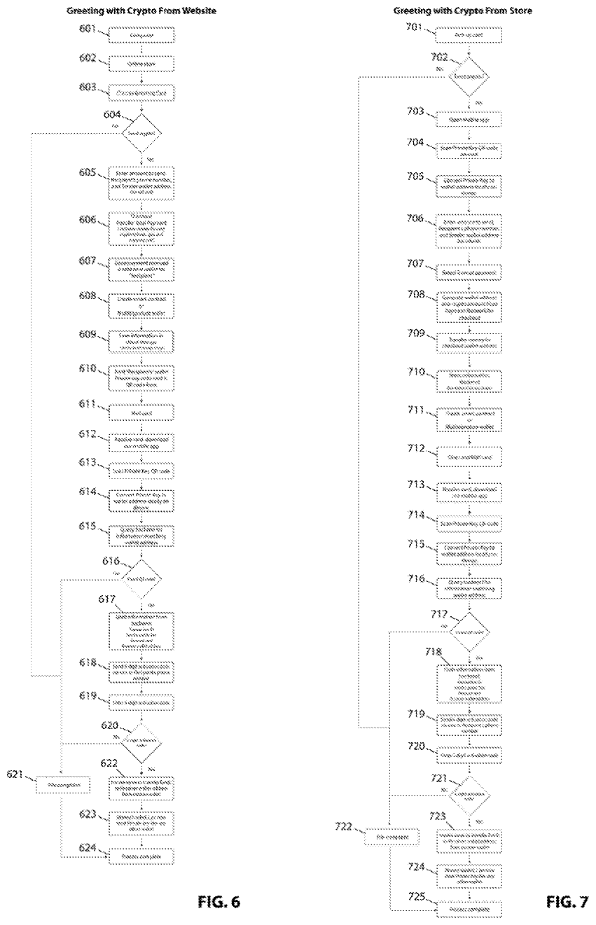

FIG. 6 illustrates a flow diagram of an example method of a user purchasing a card, such as, e.g., a physical printed card or a digital card, from a website according to example embodiments. In step 601, a user may gain access to a computer, such as, e.g., a desktop computer or a mobile computing device. In step 602, the user may direct an Internet browser of the computer to an online store on a website. In step 603, the user may select a greeting card to purchase from among a plurality of options. In step 604, the user may choose to either load cryptocurrency value onto the card or forego loading cryptocurrency value onto the card. If the user chooses not to load cryptocurrency value onto the card, the method may proceed to step 624, where no card is sent, and the method ends.

If the user chooses to load cryptocurrency value onto the card, the method may proceed to step 605. In step 605, the user may enter the card value 509 to load onto the card, the recipient's phone number 513, and the sender's wallet address 506 in the event of a refund, based on predetermined criteria, such as, e.g., the recipient not claiming the cryptocurrency value by a predetermined time. Recipient's phone number 513 may be used to send recipient an activation code 313 when the recipient receives and scans the QR code on the card. Activation code 313 may unlock funds from an escrow account, such as, e.g., smart contract address 507 or multi-signature wallet address 508, and transfer the cryptocurrency funds to recipient's wallet address 505. Sender's wallet address 506 may be used for refunds, and computer code may be built into smart contracts 309 to automatically refund the user if the recipient does not claim funds within a predetermined duration of time.

In step 606, user may complete transaction checkout process by paying the sum of the total of card price; cryptocurrency value loaded onto the card; transfer fees, such as, e.g., “gas,” “coins,” or any other suitable unit of value; and shipping costs. This payment may be transferred to payment network 106 for processing and confirmation, after which payment network 106 may communicate the confirmation of payment to website 101 and server 103 using any suitable method known in the art, such as, e.g., webhook technology. In step 607, server 103 may create a new digital wallet for the recipient upon confirmation. In step 608, server 103 may create an escrow wallet, such as, e.g., smart contract address 507 or multi-signature wallet address 508, depending on the cryptocurrency being used. When using a smart contract 309, the recipient's new wallet address 505 information may be stored in the smart contract 309 itself, therefore when triggered to transfer funds, the contract may transfer the funds to that address. By contrast, multi-signature technology may require more than one key to authorize a transaction. Multi-signature wallet 312 may be configured to authorize a transaction when, for example, two of three total private keys are valid. In an embodiment where the owner of server 103 controls two of the three keys, manual authorization by the owner of server 103 may be required to process a refund.

In step 609, information about the escrow wallet, such as, e.g., smart contract address 507 or multi-signature wallet address 508, and recipient wallet address 505 may be stored persistently in cloud storage database 104. In step 610, recipient's wallet private key may be printed onto the card as a QR code or any suitable format known in the art. In step 611, the card may be transferred to the recipient. In one embodiment, a physical card may be mailed to the recipient. In another embodiment, a digital card may be digitally transferred to the recipient, such as, e.g., by email or as a feature of mobile application 206. At this time, recipient wallet address 505 does not hold any value, as value may only be transferred to recipient wallet address 505 from the escrow account when the activation code 313 is entered.

In step 612, the recipient may receive the card and download mobile application 206. In step 613, the recipient may then use mobile application 206 to scan private key 510, which mobile application 206 may encrypt before transmitting it to server 103, in QR Code format. In step 614, server 103 may receive encrypted private key 510 from the recipient and a corresponding recipient wallet address 505 may be generated locally on recipient's computing device. In step 615, recipient wallet address 505 may now be used to query cloud storage database 104 for information pertinent to recipient wallet address 505. In step 616, if no information for recipient wallet address 505 is found, the recipient may file a complaint, and the method may proceed to step 621.

Otherwise, if information for recipient wallet address 505 is found, the method proceeds to step 617. In step 617, once recipient wallet address 505 is found in cloud storage database 104, server 103 may retrieve relevant information, including, but not limited to, transaction information 501, sender wallet address 506, card value 509, and recipient wallet address 505. In one embodiment, server 103 may not be configured to retrieve activation code 313 for security reasons. In step 618, server 103 may transmit to recipient a five-digit activation code 313 to recipient's phone number 513.

In step 619, the recipient may then enter activation code 313. In step 620, if activation code 313 is incorrect, then the method may proceed to step 621, where recipient may file a complaint. Otherwise, if activation code 313 is correct, then the method may proceed to step 622. In step 622, server 103 may transfer cryptocurrency funds from the escrow wallet, such as, e.g., smart contract address 507 or multi-signature wallet address 508, to recipient's wallet address 505.

For smart contracts 309, server 103 may communicate with the appropriate blockchain network 102 to transfer cryptocurrency funds from smart contract address 507 to this new recipient wallet address 505. Smart contract 309 may be configured such that only the owner of the server may invoke the transfer of cryptocurrency value to another address. For multi-signature wallets 312, server 103 may communicate with the appropriate blockchain network 102 to authorize the transfer using one or more private keys 510, where a majority of private keys 510 may be controlled by the owner of server 103, and a minority of private keys 510 is controlled by the recipient. In one embodiment, there may be three private keys 510, two of which may be controlled by the owner of server 103, and one of which may be controlled by the recipient. During transfer confirmation, the recipient may monitor the status of the transfer using mobile application 105. In step 623, after the transaction is complete, server 103 may transmit a push notification to the recipient that the card has been activated and the cryptocurrency value sent by the user has been transferred from the escrow account to recipient wallet address 505. In step 624, the method concludes.

FIG. 7 illustrates a flow diagram of an example method of a user purchasing a card at the store or in person according to example embodiments. These cards may already have a recipient's encrypted private key 510 in QR Code format printed on them, and recipient wallet addresses 505 may be generated by a local computer 201, which may communicate with server 203, which in turn may communicate with blockchain network 202 to create recipient wallets 308, information about which may be transmitted back to local computer 201. Information related to newly created recipient wallets 308 may be saved in cloud storage database 204 along with the card's SKU numbers. These recipient wallets 308 may have a zero balance, as no cryptocurrency value may have been loaded yet.

In step 701, a user may obtain a card from a point of sale, such as, e.g., a kiosk in a store. In step 702, the user may choose to either load cryptocurrency value onto the card or forego loading cryptocurrency value onto the card. If the user chooses not to load cryptocurrency value onto the card, the method may proceed to step 725, where no value is loaded onto the card, and the method ends. If the user chooses to load cryptocurrency value onto the card, the method may proceed to step 703. In step 703, the user may download mobile application 206. In step 704, the user may scan the encrypted private key 510 represented in QR Code format on the card. In step 705, mobile application 206 may generate recipient wallet address 505 from encrypted private key 510. In step 706, the user may then enter a desired card value 509 of cryptocurrency to load onto the card, the recipient's phone number 513, and sender's wallet address 506. Recipient's phone number 513 may be used by mobile application 206, in conjunction with server 203, to send recipient an activation code 313 via any suitable method known in the art, such as, e.g., text message, short message service (“SMS”), or push notification, when recipient scans the QR code printed on the card. Sender's wallet address 506 may be used in case of a refund based on predetermine criteria, such as, e.g., if recipient does not claim the cryptocurrency value within a predetermined time.

In step 707, when ready to checkout, the user may select a form of payment, such as, e.g., using cryptocurrency or fiat currency, such as, e.g., United States Dollars. In step 708, if the user decides to pay with cryptocurrency, the transaction data explained in FIG. 4 may be transmitted to payment network 205, which generates wallet address 407 to which payment for the transaction may be transferred by the user, and mobile application 206 displays to the user cryptocurrency amount owed 406 and wallet address 407. In step 709, the user may transmit cryptocurrency amount owed 406 to wallet address 407. In step 710, transaction data, including, but not limited to, including transaction information 501, user information 502, card value 509, and recipient's phone number 513 may be stored persistently in cloud storage database 204.

In step 711, cron job scheduler 304 may monitor cloud storage database 204 at to a predetermined frequency of time for the status of payment. Once blockchain network 202 has confirmed the payment, server 203 may create an escrow wallet, such as, e.g., smart contract address 507 or multi-signature wallet address 508, and fund it with cryptocurrency value from wallet vault 305, where the cryptocurrency value may be equivalent card value 509 with which the user loaded the card. Once the escrow account is created, a push notification may be sent to the user communicating that the card has been loaded with cryptocurrency value and ready to be gifted. In step 712, the user may mail or otherwise give the card to a recipient.

In step 713, the recipient may receive the card and download mobile application 206. In step 714, the recipient may then use mobile application 206 to scan private key 510, which mobile application 206 may encrypt before transmitting it to server 203, in QR Code format. In step 715, server 203 may receive encrypted private key 510 from the recipient a corresponding recipient wallet address 505 may be generated locally on recipient's computing device. In step 716, recipient wallet address 505 may now be used to query cloud storage database 204 for information pertinent to recipient wallet address 505. In step 717, if no information for recipient wallet address 505 is found, the recipient may file a complaint, and the method may proceed to step 722.

Otherwise, if information for recipient wallet address 505 is found, the method proceeds to step 718. In step 718, once recipient wallet address 505 is found in cloud storage database 204, server 203 may retrieve relevant information, including, but not limited to, transaction information 501, sender wallet address 506, card value 509, and recipient wallet address 505. In one embodiment, server 103 may not be configured to retrieve activation code 313 for security reasons. In step 719, server 203 may transmit to recipient a five-digit activation code 313 to recipient's phone number 513.

In step 720, the recipient may then enter activation code 313. In step 721, if activation code 313 is incorrect, then the method may proceed to step 722, where recipient may file a complaint. Otherwise, if activation code 313 is correct, then the method may proceed to step 723. In step 723, server 203 may transfer cryptocurrency funds from the escrow wallet, such as, e.g., smart contract address 507 or multi-signature wallet address 508, to recipient's wallet address 505.

For smart contracts 309, server 203 may communicate with the appropriate blockchain network 202 to transfer cryptocurrency funds from smart contract address 507 to this new recipient wallet address 505. Smart contract 309 may be configured such that only the owner of the server may invoke the transfer of cryptocurrency value to another address. For multi-signature wallets 312, server 203 may communicate with the appropriate blockchain network 202 to authorize the transfer using one or more private keys 510, where a majority of private keys 510 may be controlled by the owner of server 203, and a minority of private keys 510 is controlled by the recipient. In one embodiment, there may be three private keys 510, two of which may be controlled by the owner of server 203, and one of which may be controlled by the recipient. During transfer confirmation, the recipient may monitor the status of the transfer using mobile application 206. In step 724, after the transaction is complete, server 203 may transmit a push notification to the recipient that the card has been activated and the cryptocurrency value sent by the user has been transferred from the escrow account to recipient wallet address 505. In step 725, the method concludes.

The above embodiments may be implemented in hardware, in a computer program executed by a processor, in firmware, or in a combination of the above. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

Although an exemplary embodiment of at least one of a system, method, and non-transitory computer readable medium has been illustrated in the accompanied drawings and described in the foregoing detailed description, it will be understood that the application is not limited to the embodiments disclosed, but is capable of numerous rearrangements, modifications, and substitutions as set forth and defined by the following claims. For example, the capabilities of the system of the various figures can be performed by one or more of the modules or components described herein or in a distributed architecture and may include a transmitter, receiver or pair of both. For example, all or part of the functionality performed by the individual modules, may be performed by one or more of these modules. Further, the functionality described herein may be performed at various times and in relation to various events, internal or external to the modules or components. Also, the information sent between various modules can be sent between the modules via at least one of: a data network, the Internet, a voice network, an Internet Protocol network, a wireless device, a wired device and/or via plurality of protocols. Also, the messages sent or received by any of the modules may be sent or received directly and/or via one or more of the other modules.

One skilled in the art will appreciate that a “system” could be embodied as a personal computer, a server, a console, a personal digital assistant (PDA), a cell phone, a tablet computing device, a smartphone or any other suitable computing device, or combination of devices. Presenting the above-described functions as being performed by a “system” is not intended to limit the scope of the present application in any way, but is intended to provide one example of many embodiments. Indeed, methods, systems and apparatuses disclosed herein may be implemented in localized and distributed forms consistent with computing technology.

It should be noted that some of the system features described in this specification have been presented as modules, in order to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module. Further, modules may be stored on a computer-readable medium, which may be, for instance, a hard disk drive, flash device, random access memory (RAM), tape, or any other such medium used to store data.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

It will be readily understood that the components of the application, as generally described and illustrated in the figures herein, may be arranged and designed in a wide variety of different configurations. Thus, the detailed description of the embodiments is not intended to limit the scope of the application as claimed, but is merely representative of selected embodiments of the application.

One having ordinary skill in the art will readily understand that the above may be practiced with steps in a different order, and/or with hardware elements in configurations that are different than those which are disclosed. Therefore, although the application has been described based upon these preferred embodiments, it would be apparent to those of skill in the art that certain modifications, variations, and alternative constructions would be apparent.

While preferred embodiments of the present application have been described, it is to be understood that the embodiments described are illustrative only and the scope of the application is to be defined solely by the appended claims when considered with a full range of equivalents and modifications (e.g., protocols, hardware devices, software platforms etc.) thereto.

What is claimed is:

1. A method, comprising:
a user selecting one or more of a printed medium or digital medium from among a plurality of available printed media or digital media;
the user selecting a unit of value from among a plurality of available units of value;
the user selecting an amount of the selected unit of value to load onto the one or more selected media;
the user providing contact information for a recipient of value;
the user providing account information for a transmitter of value;
transmitting information pertaining to the selected printed medium, unit of value, and amount, and provided contact information and account information to a server;
the server calculating the costs of a transaction based on the information;
the user authorizing the transaction;
the server creating an escrow account to store value sent in the transaction;
the server creating a secure recipient account for a recipient;
the server creating a digital means of implementing the transaction according to predetermined criteria;
the server storing persistent information about the transaction;
the server causing secure recipient account information to be printed on the one more or selected media;
the one or more media being transmitted to the recipient;
the recipient using a mobile application to interpret the secure recipient account information printed on the one or more media;
the mobile application querying the server for information about the secure recipient account;
the server transmitting a response to the query with information about the secure recipient account and the transaction;
the recipient using the response to activate the secure recipient account and authorize a transfer of value into the recipient account; and
the server transferring value from the transaction from the escrow account to the recipient account.

2. The method of claim 1, wherein the user selects an amount of the selected unit of value to load onto the one or more selected media using one or more of a point-of-sale system or an online website.

3. The method of claim 1, wherein the media comprise one or more of a greeting card, digital greeting card, gift card, postcard, business card, flyer, receipt, check, order paper, bearer paper, negotiable instrument, or a digital manifestation thereof.

4. The method of claim 1, wherein the unit of value comprises one or more of a cryptocurrency, fiat currency, or digital currency.

5. The method of claim 1, wherein the accounts are cryptocurrency currency wallets.

6. The method of claim 1, wherein the account information is a cryptocurrency wallet address.

7. The method of claim 1, wherein the digital means of implementing the transaction comprise one or more of smart contracts or multi-signature cryptocurrency wallets.

8. The method of claim 1, wherein the server storing persistent information comprises one or more of cloud storage platforms or blockchain networks.

9. The method of claim 1, wherein the secure recipient account information is printed on the one or more media as a quick response (“QR”) code.

10. The method of claim 1, wherein the mobile application interprets the secure recipient account information printed on the one or more media using a quick response (“QR”) code scanner.

11. The method of claim 1, wherein the authorizations are implemented using one or more of encrypted private digital keys or activation codes.

12. A system, comprising:
one or more websites configured to receive user input and display cryptocurrency transaction data;
one or more mobile applications configured to receive user input, interpret secure recipient account information printed on one or more media, and display cryptocurrency transaction data, where the one or more media is one or more of printed media or digital media;
one or more servers configured to receive user input, calculate cryptocurrency transaction costs, communicate with blockchain networks to create cryptocurrency digital wallets from encrypted digital private key information, transmit cryptocurrency transaction data to mobile applications and blockchain networks, and implement cryptocurrency value transfers between cryptocurrency addresses;
one or more payment networks configured to receive, process, and confirm cryptocurrency transactions, and communicate using webhook technology;
one or more smart contracts configured to administer the transfer of cryptocurrency value according to predetermined criteria;
one or more multi-signature wallets configured to administer the transfer of cryptocurrency value according to predetermined criteria and subject to the provision of digital authorization keys;
one or more blockchain networks configured to create cryptocurrency wallets and transaction data and stored transaction data in decentralized and immutable blocks of data;
one or more cloud storage databases configured to store persistent cryptocurrency transaction data, cryptocurrency digital addresses, and encrypted digital keys; and
one or more points-of-sale configured to receive user input, load secure cryptocurrency transaction data onto one or more media, and display cryptocurrency transaction data.

13. A non-transitory computer readable storage medium configured to store instructions that when executed causes a processor to perform:
receiving user input selecting one or more of a printed medium or digital medium from among a plurality of available printed media or digital media;
receiving user input selecting a unit of value from among a plurality of available units of value;
receiving user input selecting an amount of the selected unit of value to load onto the selected printed medium;
receiving user input providing contact information for a recipient of value;
receiving user input providing account information for a transmitter of value;
transmitting information pertaining to the one or more media, unit of value, and amount, and provided contact information and account information to a server;
leveraging the server to calculate the costs of a transaction based on the information;
receiving user input authorizing the transaction;
leveraging the server to create an escrow account to store value sent in the transaction;
leveraging the server to create a secure recipient account for a recipient;
leveraging the server to create a digital means of implementing the transaction according to predetermined criteria;
leveraging the server to store persistent information about the transaction;
leveraging the server to cause secure recipient account information to be printed on the printed medium;
interpreting the secure recipient account information printed on the one or more media;
querying the server for information about the secure recipient account;
leveraging the server to transmit a response to the query with information about the secure recipient account and the transaction;
receiving recipient input to activate the secure recipient account and authorize transfer value into the recipient account; and
leveraging the server to transfer value from the transaction from the escrow account to the recipient account.

14. The non-transitory computer readable storage medium of claim 13, wherein the unit of value comprises one or more of a cryptocurrency, fiat currency, or digital currency.

15. The non-transitory computer readable storage medium of claim 13, wherein the accounts are cryptocurrency currency wallets.

16. The non-transitory computer readable storage medium of claim 13, wherein the account information is a cryptocurrency wallet address.

17. The non-transitory computer readable storage medium of claim 13, wherein the digital means of implementing the transaction comprise one or more of smart contracts or multi-signature cryptocurrency wallets.

18. The non-transitory computer readable storage medium of claim 13, wherein the server storing persistent information comprises one or more of cloud storage platforms or blockchain networks.

19. The non-transitory computer readable storage medium of claim 13, wherein the wherein the mobile application interprets the secure recipient account information printed on the one or more media using a quick response (“QR”) code scanner.

20. The non-transitory computer readable storage medium of claim 13, wherein the authorizations are implemented using one or more of encrypted private digital keys or activation codes.
